(19) United States
(12) Patent Application Publication
(10) Pub. No.: US 2004/0221729 A1
(43) Pub. Date: Nov. 11, 2004

(54) Bread maker

(75) Inventors: Jae-ryong Park, Suwon-city (KR); Yong-hyun Kwon, Suwon-city (KR); Chul Kim, Anyang-city (KR); Tae-uk Lee, Suwon-city (KR); Han-jun Sung, Suwon-city (KR); Jang-woo Lee, Suwon-city (KR); Dong-bin Lim, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/803,913

(22) Filed: Mar. 19, 2004

(30) Foreign Application Priority Data
May 7, 2003 (KR) 2003-29090

(51) Int. Cl. A23L 1/00

(52) U.S. Cl. 99/348

(57) ABSTRACT

The present invention relates to a bread maker including: a main body divided into an oven compartment and a component compartment; upper and lower kneading drums which are rotatably provided at upper and lower parts inside of the oven compartment and wind opposite ends of a mixing bag filled with raw materials for making bread; and a drum driving part placed in the component compartment to rotate the upper and lower kneading drums, the drum driving part including: a driving motor generating a driving force to rotate the lower kneading drum; a reduction gear which speed-reduces the driving force of the driving motor and has an output shaft thereof transmitting the speed-reduced driving force to the lower kneading drum; a connector connecting the output shaft and the lower kneading drum; upper and lower pulleys rotatably connected to the upper and lower kneading drums, respectively; and a driving belt connected to the upper and lower pulleys to rotate the upper and lower kneading drums; and an engager connecting one side of the lower pulley to the connector. Thus, the driving force of the driving motor can be smoothly transmitted to the lower kneading drum, thereby providing increase productivity by reducing assembly time of the bread maker.

### CROSS-REFERENCE TO RELATED APPLICATIONS

This application claims the benefit of Korean Patent Application No. 2003-029090, filed May 7, 2003, in the Korean Intellectual Property Office, the disclosure of which is incorporated herein by reference.

### BACKGROUND OF THE INVENTION

1. Field of the Invention

The present invention relates to a bread maker, and more particularly to a bread maker having an improved driving force transmission structure.

2. Description of the Related Art

Conventionally, various bread makers have been developed allowing a user to easily make bread by automatically performing multiple steps such as kneading, leavening and baking of raw materials in order to provide finished bread to the user.

For example, a bread maker disclosed in Korean Patent Publication No. 1991-10203 includes a pair of parallel kneading drums which are disposed at upper and lower parts of an oven compartment and rotated in clockwise and counterclockwise directions; a baking tray placed between the pair of kneading drums; and a heater to heat the inside of the oven compartment.

In this bread maker, opposite ends of a mixing bag filled with raw materials for bread, such as flour and baking powder, are wound by the pair of the kneading drums and then the mixing bag is reciprocated up and down for a predetermined period of time, so that the raw materials for bread in the mixing bag are kneaded.

Thereafter, a cutting unit cuts the mixing bag, so that only the kneaded dough moves into the baking tray. Then, the heater heats the interior of the oven compartment, making bread in the baking tray by leavening and baking the dough for a predetermined period of time.

In the conventional bread maker, a reversible type motor rotates the pair of kneading drums reciprocating the mixing bag up and down. The mechanism for transmitting the driving force generated by the motor to the kneading drums needs to be efficiently designed for high productivity in such a way that each part thereof can be easily replaced so as to reduce assembling process time.

### SUMMARY OF THE INVENTION

Accordingly, it is an aspect of the present invention to provide a bread maker having an improved driving force transmission mechanism providing an increase in productivity by reducing the time required for assembling the bread maker.

Additional aspects and advantages of the invention will be set forth in part in the description which follows and, in part, will be obvious from the description, or may be learned by practice of the invention.

The foregoing and/or other aspects of the present invention are also achieved by providing a bread maker comprising: a main body divided into an oven compartment and a component compartment; upper and lower kneading drums which are rotatably provided at upper and lower parts inside of the oven compartment and wind opposite ends of a mixing bag filled with raw materials for bread; and a drum driving part placed in the component compartment to rotate the upper and lower kneading drums, the drum driving part including: a driving motor generating a driving force to rotate the lower kneading drum; a reduction gear which speed-reduces the driving force of the driving motor and has an output shaft thereof transmitting the speed-reduced driving force to the lower kneading drum; a connector connecting the output shaft and the lower kneading drum; upper and lower pulleys rotatably connected to the upper and lower kneading drums, respectively; and a driving belt connected to the upper and lower pulleys to rotate the upper and lower kneading drums, wherein one side of the lower pulley is connected to the connector by an engager.

According to an aspect of the invention, the engager includes a plurality of engaging projections projected in a radial direction relative to the axis of the output shaft on an outer surface of the connector; and a plurality of projections accommodating grooves formed in the lower pulley to accommodate the engaging projections.

According to an aspect of the invention, three engaging projections are uniformly distributed on the outer surface of the connector.

According to an aspect of the invention, the reduction gear includes a worm connected to the shaft of the driving motor and a worm wheel engaged with the worm, and a gear case accommodating the worm and the worm wheel.

### BRIEF DESCRIPTION OF THE DRAWINGS

These and other aspects and advantages of the present invention will become apparent and more readily appreciated from the following description of the embodiments, taken in conjunction with the accompany drawings of which:

FIG. 1 is a perspective view of a bread maker according to the present invention;

FIG. 2 is a partially cut-away perspective view of a component compartment of FIG. 1;

FIG. 3 is an exploded perspective view of a drum driving part of FIG. 2.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

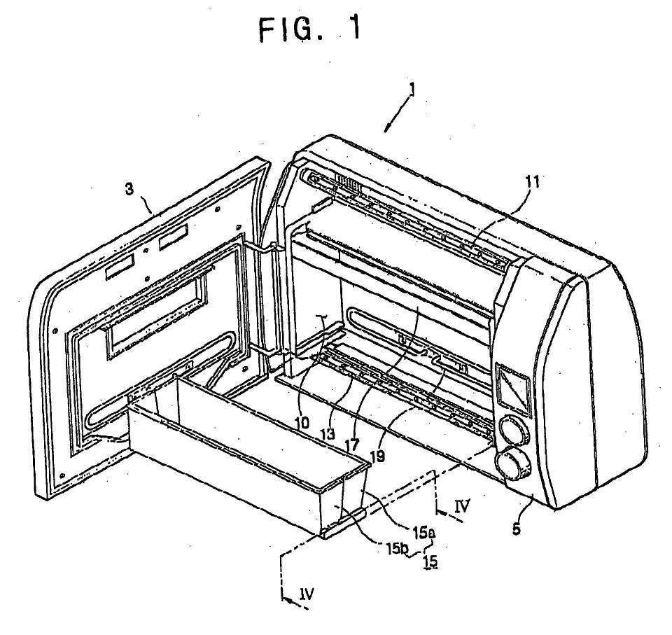

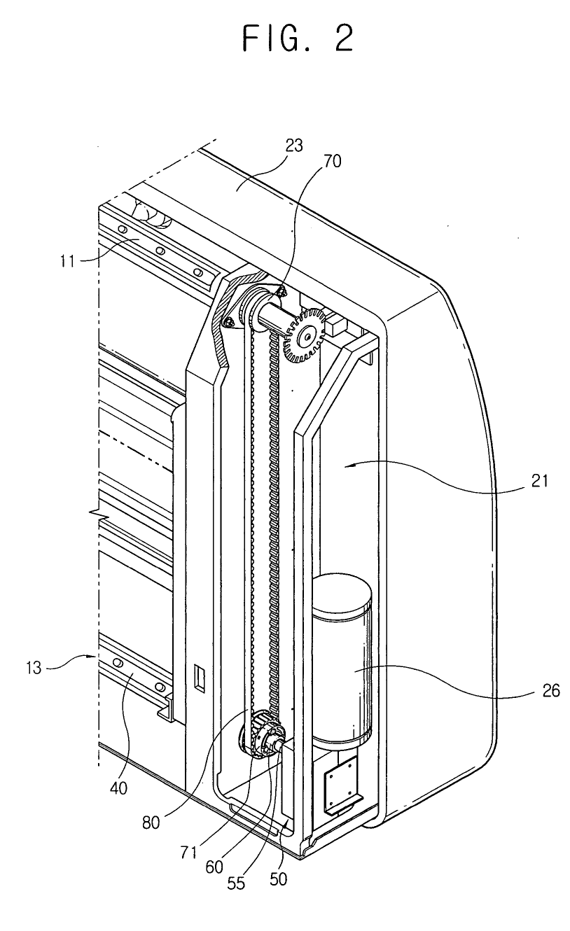

As shown in FIGS. 1 through 3, a bread maker of the present invention comprises: a main body 1 divided into an oven compartment 10 and a component compartment 5; a door 3 in the front of the main body 1 to open and close a front opening of the oven compartment 10; and an operation display panel (not shown) on a front side of the main body 1 to display an operation state of the main body 1.

In upper and lower parts inside of the oven compartment 10 are placed upper and lower kneading drums 11 and 13 which are rotatably disposed in parallel to wind a predetermined length of opposite ends of a mixing bag (not shown), filled with raw materials for making bread, in clockwise and counterclockwise directions. In a lower part of the oven compartment 10, a baking tray 15 containing kneaded materials therein is provided between the upper and lower kneading drums 11 and 13. Between the upper kneading drum 11 and the baking tray 15 is placed a pair of dough-blocking members 17 preventing the raw materials kneaded in the mixing bag from being moved toward the upper kneading drum 11.

The respective upper and lower kneading drums 11 and 13 have almost the same shape. Each of the kneading drums comprises: a drum main body 40 which is formed along a longitudinal direction thereof with a plurality of holding projections (not shown) to be inserted in holding holes (not shown) formed at end parts of the mixing bag; the driving shaft part 41 which is extended outward from one end of the drum main body 40 and is rotatably supported on a wall of a first component compartment 21 (to be described later); and a supporting shaft part (not shown) which is extended outward from the other end of the drum main body 40 and is supported on the inner wall of the oven compartment 10 on the opposite side of the wall supporting the driving shaft part 41 so as to be rotated in clockwise and counterclockwise directions.

The baking tray 15 forms a box having a top opening by combining first and second trays 15a and 15b of “L” shapes symmetrical to each other.

At upper and lower parts of the rear inner wall of the oven compartment 10 and upper and lower parts of the inside wall of the door 3, baking heaters 19 are provided to heat the inside of the oven compartment 10.

The component compartment 5 includes the first component compartment 21 beside the oven compartment 10 and a second component compartment 23 behind the oven compartment 10. Inside the first component compartment 21 is placed a drum driving part (to be described later) rotating the upper and lower kneading drums 11 and 13 in clockwise and counterclockwise directions.

The drum driving part comprises: a driving motor 26 to rotate the lower kneading drum 13; a reduction gear 50 reducing the number of rotations of the driving motor 26; a connector 60 connecting an output shaft 55 of the reduction gear 50 and the driving shaft part 41 of the lower kneading drum 13; upper and lower pulleys 70 and 71 rotatably connected to the driving shaft parts 41 of the upper and lower kneading drums 11 and 13; and a driving belt 80 which is connected to the pair of pulleys 70 and 71 and rotates the upper and lower kneading drums 11 and 13.

A driving force generated by the driving motor 26 is used to rotate the lower kneading drum 13 and transmitted to the driving shaft part 41 of the lower kneading drum 13 connected to the output shaft 55 and the connector 60 by means of the reduction gear 50 located in the lower part of the driving motor 26.

The reduction gear 50 comprises a worm gear set having a worm 53 and a worm wheel 54 in a gear case 51 located under the driving motor 26 and accommodating the worm gear set.

The worm 53 is connected to the end of the shaft 52 of the driving motor 26 and the worm wheel 54 is connected to the output shaft 55, which in turn is connected to the driving shaft part 41 of the lower kneading drum 13 by the connector 60 and is engaged with the worm 53.

One side of the connector 60 is connected to the output shaft 55 having the worm wheel 54 and the other side thereof is connected to the lower pulley 71 rotatably connected to the driving shaft part 41 of the lower kneading drum 13. The connector 60 transmits the driving force from the motor 26 via the reduction gear 50 to the lower kneading drum 13.

Between the connector 60 and the lower pulley 71 is placed an engager to make sure that the driving force speed-reduced of the reduction gear 50 is transmitted to the lower kneading drum, even if the connector 60 and the lower pulley 71 are not assembled at the exact assembling positions.

The engager includes a plurality of engaging projections 90 projected in a radial direction on an outer surface side of the connector 60; and a plurality of projections accommodating grooves 91 provided at a corresponding position of the lower pulley 71 to accommodate the engaging projections 90 of the connector 60.

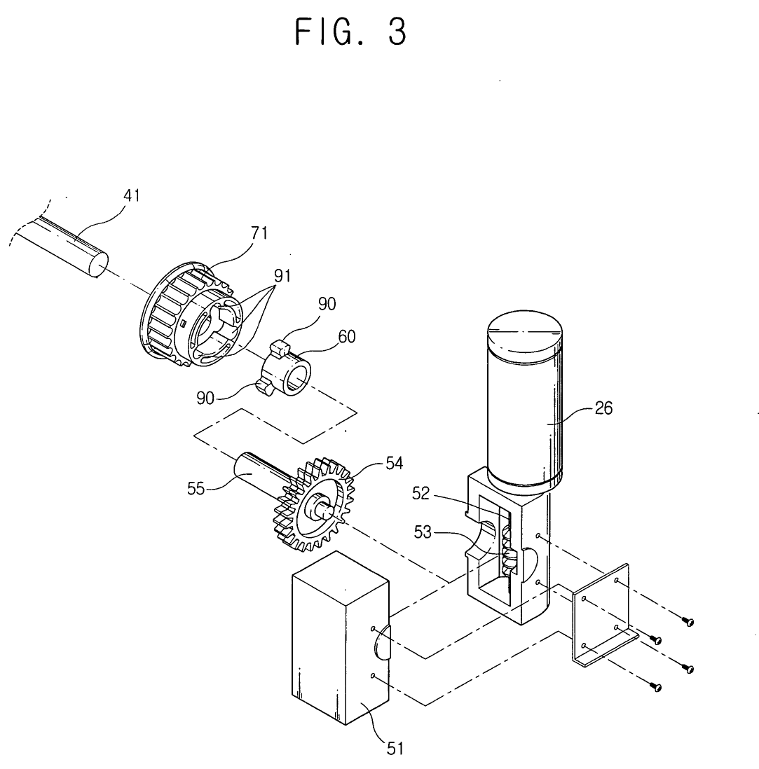

The engaging projections 90 are projected in a radial direction relative to the axis of the output shaft 55 on the outer surface of the connector 60. As shown in FIG. 3, three equally spaced engaging projections 90 are projected on the outer surface of the connector 60.

The projections accommodating grooves 91 of the lower pulley 71 are distributed in a radial direction relative to the axis of the output shaft 55, matching the number of engaging projections 90.

With this configuration, when the driving motor 26 operates, the speed-reduced driving force generated by the driving motor 26 is transmitted to the reduction gear 50. The speed-reduced driving force is responsible for rotating the lower kneading drum 13 as well as the upper kneading drum 11 connected to the lower kneading drum 13 by the transmitting belt 80.

Regarding the assembly of the drum driving part which rotates the upper and lower kneading drums 11 and 13 in clockwise and counterclockwise directions, the connector 60 and the lower pulley 71 can be coupled with much ease only by accommodating the engaging projections 90 of the connector 60 in the projections accommodating grooves 91 of the lower pulley 71. This guarantees that the driving force generated by the driving motor 26 is transmitted to the lower kneading drum 13, even if the connector 60 and the lower pulley 71 are not assembled at the exact assembling positions. This saves time and effort assembling the connector 60 and the lower pulley 71, and further the bread maker as a whole.

As described above, according to the present invention, the driving force of the driving motor can be smoothly transmitted to the lower kneading drum, thereby providing increased productivity by reducing time taken for assembling the bread maker.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A bread maker comprising: a main body divided into an oven compartment and a component compartment; upper and lower kneading drums which are rotatably provided at upper and lower parts inside of the oven compartment and wind opposite ends of a mixing bag filled with raw materials for bread; and a drum driving part placed in the component compartment to rotate the upper and lower kneading drums, the drum driving part comprising:
a driving motor generating a driving force to rotate the lower kneading drum;
a reduction gear which speed-reduces the driving force of the driving motor and has an output shaft thereof transmitting the speed-reduced driving force to the lower kneading drum;
a connector connecting the output shaft and the lower kneading drum;
upper and lower pulleys rotatably connected to the upper and lower kneading drums, respectively;
a driving belt connected to the upper and lower pulleys to rotate the upper and lower kneading drums; and
an engager connecting one side of the lower pulley to the connector.

2. The bread maker according to claim 1, wherein the engager comprises a plurality of engaging projections projected in a radial direction relative to an axis of the output shaft on an outer surface of the connector; and
a plurality of projections accommodating grooves formed in the lower pulley to accommodate the plurality of engaging projections.

3. The bread maker according to claim 2, wherein three engaging projections are uniformly distributed on the outer surface of the connector.

4. The bread maker according to claim 2, wherein the reduction gear includes a worm connected to a shaft of the driving motor and a worm wheel engaged with the worm, and a gear case accommodating the worm and the worm wheel.

5. A driving mechanism, comprising:
a driving motor generating a driving force to rotate a first drum;
a reduction gear controlling the driving force of the driving motor coupled to an output shaft transmitting the driving force to the first drum;
a connector connecting the output shaft and the first drum;
a first pulley rotatably connected to the first drum;
a second pulley rotatably connected to a second drum;
a driving belt connected to the first and second pulleys to rotate the first and second drums; and
an engager connecting one side of the first pulley to the connector.

6. The drum driving mechanism according to claim 5, wherein the engager includes a plurality of engaging projections projected in a radial direction relative to an axis of the output shaft on an outer surface of the connector and a plurality of projections accommodating grooves formed in the first pulley to accommodate the engaging projections.

7. The drum driving mechanism according to claim 6, wherein at least one engaging projection is located on the outer surface of the connector.

8. The drum driving mechanism according to claim 6, wherein the reduction gear further includes a worm connected to a shaft of the driving motor and a worm wheel engaged with the worm, and a gear case accommodating the worm and the worm wheel.

9. A bread maker comprising an oven compartment and a component compartment, wherein the component compartment further comprises a drum driving mechanism, the drum driving mechanism including:
a driving motor rotating a first kneading drum;
a reduction gear controlling the number of rotations of the driving motor;
a connector connecting an output shaft of the reduction gear and connecting a first driving shaft part of the first kneading drum;
a second pulley rotatably coupled to a second driving shaft part of a second kneading drum;
a first pulley rotatably coupled to the first driving shaft part of the first kneading drum; and
a driving belt coupled to the first and second pulleys and rotating the first and second kneading drums.

10. The bread maker according to claim 9, wherein a driving force generated by the driving motor is used to rotate the first kneading drum and transmitted to the first driving shaft part of the first kneading drum connected to the output shaft and the connector by the reduction gear located in a first part of the driving motor.

11. The bread maker according to claim 9, wherein the reduction gear further comprises a worm gear set having a worm and a worm wheel in a gear case located under the driving motor.

12. The bread maker according to claim 11, wherein the worm is coupled to an end of a driving motor shaft, and the worm wheel is coupled to the output shaft which is connected to the driving shaft part of the first kneading drum by the connector and engaged with the worm.

13. The bread maker according to claim 12, wherein one side of the connector is connected to the output shaft having the worm wheel and a other side of the connector is connected to the first pulley rotatably connected to the driving shaft part of the first kneading drum.

14. The bread maker according to claim 13, wherein the connector transmits the driving force from a motor by the reduction gear to the first kneading drum.

15. The bread maker according to claim 9, further comprising an engager provided between the connector and the first pulley.

16. The bread maker according to claim 15, wherein the engager further includes a plurality of engaging projections projecting in a radial direction on an outer surface side of the connector, and a plurality of projections accommodating grooves provided at corresponding positions of the first pulley to accommodate the engaging projections of the connector.

17. The bread maker according to claim 16, wherein the plurality of engaging projections are projected in a radial direction relative to an axis of the output shaft on the outer surface of the connector.

18. The bread maker according to claim 16, wherein the plurality of projections accommodating grooves of the first pulley are distributed in a radial direction relative to an axis of the output shaft and match the engaging projections.
